(19) United States
(12) Patent Application Publication
(10) Pub. No.: US 2013/0013899 A1
(43) Pub. Date: Jan. 10, 2013

(54) Using Hardware Transaction Primitives for Implementing Non-Transactional Escape Actions Inside Transactions

(75) Inventors: Christopher M. Barton, Stouffville (CA); Harold W. Cain, III, Hartsdale, NY (US); Bradly G. Frey, Austin, TX (US); Hung Q. Le, Austin, TX (US); Maged M. Michael, Danbury, CT (US); Raul E. Silvera, Woodbridge (CA); Derek E. Williams, Austin, TX (US); Michael Wong, Toronto (CA); Peng Wu, Mt. Kisco, NY (US)

(73) Assignee: INTERNATIONAL BUSINESS MACHINES CORPORATION, Armonk, NY (US)

(21) Appl. No.: 13/176,833

(22) Filed: Jul. 6, 2011

(51) Int. Cl. G06F 9/30

(52) U.S. Cl. 712/220; 712/E09.032

(57) ABSTRACT

Mechanisms are provided for performing escape actions within transactions. These mechanisms execute a transaction comprising a transactional section and an escape action. The transactional section is comprised of one or more instructions that are to be executed in an atomic manner as part of the transaction. The escape action is comprised of one or more instructions to be executed in a non-transactional manner. These mechanisms further populate at least one actions list data structure, associated with a thread of the data processing system that is executing the transaction, with one or more actions associated with the escape action. Moreover, these mechanisms execute one or more actions in the actions list data structure based upon whether the transaction commits successfully or is aborted.

### BACKGROUND

The present application relates generally to an improved data processing apparatus and method and more specifically to mechanisms for using hardware transaction primitives for implementing non-transactional escape actions inside transactions.

Many computing systems today make use of parallel computing architectures where multiple threads of execution can be processed at virtually the same time and thereby increase the speed by which operations are performed. In modern parallel computing architectures, shared memory is utilized where multiple threads of execution may perform operations on the same memory structures. As a result, various concurrency control mechanisms have been devised for controlling access to the shared memory to avoid corruption of data. One such concurrency mechanism is transactional memory.

Transactional memory attempts to simplify concurrent or parallel programming by allowing a group of load and store instructions to execute in an atomic manner. What is meant by an atomic manner is that mechanisms are provided that guarantee that either (1) all instructions of the transaction complete successfully or (2) no effects of the instructions of the transactions occur, i.e. the transaction is aborted and any changes made by the execution of the instructions in the transaction are rolled-back. In this way, with atomic transactions, the instructions of the transaction appear to occur all at once in a single instant between invocation and results being generated.

Hardware transactional memory systems may have modifications to the processors, caches, and bus protocols to support transactions or transaction blocks, i.e. groups of instructions that are to be executed atomically as one unit. Software transactional memory provides transactional memory semantics in a software runtime library with minimal hardware support.

As described in Bobba et al., “Performance Pathologies in Hardware Transactional Memory,” ISCA '07, Jun. 9-13, 2007, a programmer can invoke a transaction in a multi-threaded application and rely on the transactional memory system to make its execution appear atomic in a global serial order. Bobba et al. discusses conflict resolution policies in transactional memory systems, however, the concept of transactional memory was introduced by Herlihy and Moss “Transactional Memory: Architectural Support for Lock-Free Data Structures,” Proceedings of the 20th Annual International Symposium on Computer Architecture, pp. 289-300, May 1993.

Transactional memory systems seek high performance by speculatively executing transactions concurrently and only committing transactions that are non-conflicting. A conflict occurs when two or more concurrent transactions access the same piece of data, e.g. a word, block, object, etc., and at least one access is a write. In such a case, one or more of the transactions are typically aborted to avoid the conflict. In some situations, transactional memory systems may resolve some conflicts by stalling one or more of the transactions so as to allow one or more other transactions to complete.

### SUMMARY

In one illustrative embodiment, a method, in a data processing system, is provided for performing escape actions within transactions. The method comprises executing, by a processor of the data processing system, a transaction comprising a transactional section and an escape action. The transactional section is comprised of one or more instructions that are to be executed in an atomic manner as part of the transaction. The escape action is comprised of one or more instructions to be executed in a non-transactional manner. The method further comprises populating, by the processor, at least one actions list data structure, associated with a thread of execution of the data processing system that is executing the transaction, with one or more actions associated with the escape action. Moreover, the method comprises executing, by the processor, one or more actions in the actions list data structure based upon whether the transaction commits successfully or is aborted.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example block diagram of a data processing system in which a transactional memory system in accordance with one illustrative embodiment may be implemented;

FIG. 2 is an example diagram illustrating an example portion of pseudocode that utilizes hardware transactional memory system;

FIG. 3 is an example diagram of code that may be used for executing a transaction having an escape action in accordance with one illustrative embodiment;

FIG. 4 is an example diagram of code implementing a memory allocation escape action in a transaction in accordance with one illustrative embodiment;

FIG. 5 is an example diagram illustrating a compilation process that may be implemented using a compiler that is configured to perform the operations for transforming and optimizing user level code into code utilizing the mechanisms of the illustrative embodiments;

FIG. 6 is a flowchart outlining an example operation for generating hardware level code from user level code in accordance with one illustrative embodiment; and

FIG. 7 is a flowchart outlining an example operation of the execution of a transaction that includes an escape action in accordance with one illustrative embodiment.

### DETAILED DESCRIPTION

The illustrative embodiments provide mechanisms for using hardware transaction primitives for implementing non-transactional escape actions inside transactions. In the context of a transactional memory programming model, it is sometimes desirable to exclude sections of a transactions from the transactional guarantee of atomicity. For example, it may be desirable to exclude sections of a transaction that typically become, or have a tendency to become, problematic for transactional memory implementations, e.g., memory allocation (malloc) operations, logging operations, statistic generating operations, or other operations that may cause a transaction to fail or abort in a predictable manner, from treatment as part of the transaction. What is meant by an operation or portion of code being treated as part of a transaction is that: (a) the memory accesses of the operation (or portion of code) are subject to conflict detection (i.e., conflicts with memory accesses of other threads); (b) the operation may consume transactional memory system resources; and (c) the operation is subject to the transactional memory system rules, e.g., the failure of the transaction if the operation contains certain actions.

Such operations, or portions of code, that are to be excluded from treatment as part of the transaction, and thus, excluded from transactional guarantees, have some common characteristics. These characteristics include: (1) their explicit exclusion from the body of the transaction is difficult; (2) their treatment by the transactional memory system as part of the transaction is unnecessary for correctness, undesirable; and/or (3) their treatment as part of the transaction is likely or certain to prevent the successful completion of the transaction. Such identification of these operations, or portions of code, may be made empirically, for example.

With regard to (1) above, usually such operations, or portions of code, are difficult to move out of a transactions' body. The reasons that this is difficult include: (a) having a dependence in the body of the transaction (e.g., inside the transaction it is determined that a block of a certain size needs to be allocated, it is desirable to exclude the allocating of a block, but then the code includes subsequent use of the allocated block in the transaction), (b) the code would be too complicated if a programmer attempts to remember that certain operations need to be performed that may have been encountered at some other level of function calls, but it is desirable to exclude these operations from being treated as part of the transaction. Designating operations as escape actions in accordance with the mechanisms of the illustrative embodiments gives the programmer this capability to exclude code sections without complicating the programmer's code.

With regard to (2) above, the reason some operations do not need to be treated as part of the transaction is that they have other means of synchronization. Such other means includes locks or common atomic operations (e.g., compare-and-swap, the pair load-linked and store-conditional, fetch-and-add, and the like). The reason some operations arc not desirable to be treated as part of the transaction is that the programmer does not want their effect to be undone if the transaction is aborted, e.g., if the programmer wants to count the number of transaction aborts.

Regarding (3) above, the reason the treatment of some operations as part of the transaction is likely (or certain) to lead to preventing the successful completion of the transaction include: (a) conflict with operations of other threads (whether the other threads are executing transactions or not), (b) consumption of limited resources of the transactional memory system (this is especially important for hardware transactional memory systems), and/or (c) the operations include actions that are not allowed by the transactional memory system (e.g., some hardware systems may not allow input/output operations inside transactions or calls to the operating system).

These operations, or portions of code, that are to be excluded from a transaction are non-transactional in nature and may have other hardware or software mechanisms to guarantee correctness of the operations, e.g., locking mechanisms, using simple atomic operations of instructions such as compare-and-swap and fetch-and-add, disabling interrupts or custom operation scheduling mechanisms, or the like. As a result, it is not necessary for the atomicity of the transaction to be used to ensure correctness of the operation. These operations will be collectively referred to herein as “escape actions” since an “escape” from the transaction is performed with regard to these operations, as described hereafter.

With the transactional memory mechanisms of the illustrative embodiments, such escape actions are facilitated using hardware primitives of a hardware transactional memory and hardware and/or software implemented structures for maintaining ordered lists of actions to be executed either on a successful commit of the transaction or an abort of the transaction. The transactional memory mechanisms of the illustrative embodiments use a lock-elision technique to ensure atomicity of transactions. Each thread has two lists of actions, a commit actions list and an abort actions list. Both lists are initially empty. Upon encountering an escape action in code of a transaction, the hardware transaction is suspended and commit and abort actions are added to the current thread's corresponding commit and abort action lists. The escape action is then executed. Once the escape action is done executing, the suspended hardware transaction is resumed. If the transaction commits, i.e. successfully completes, the thread executes the actions in the thread's corresponding commit actions list in order and then clears both its commit actions list and abort actions list. If the transaction aborts, i.e. does not successfully complete, the thread executes the actions in its abort list in reverse order and then clears both the commit actions list and the abort actions list for the thread.

Thus, with the mechanisms of the illustrative embodiments, an efficient mechanism for supporting escape actions within transactions is provided. The mechanisms of the illustrative embodiments utilize hardware primitives to begin, suspend, resume, abort, and end transactions while using hardware and/or software based mechanisms for maintaining lists of operations or actions to be performed in the event of a transaction commit or transaction abort occurring. In this way, the transaction mechanisms for handling the commit and abort of the transactional portions of the transaction are utilized to commit or abort the changes made by the transactional portions of the transaction, and the commit and abort action lists are used to handle consistency for non-transactional escape actions of the transaction.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or mbre programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

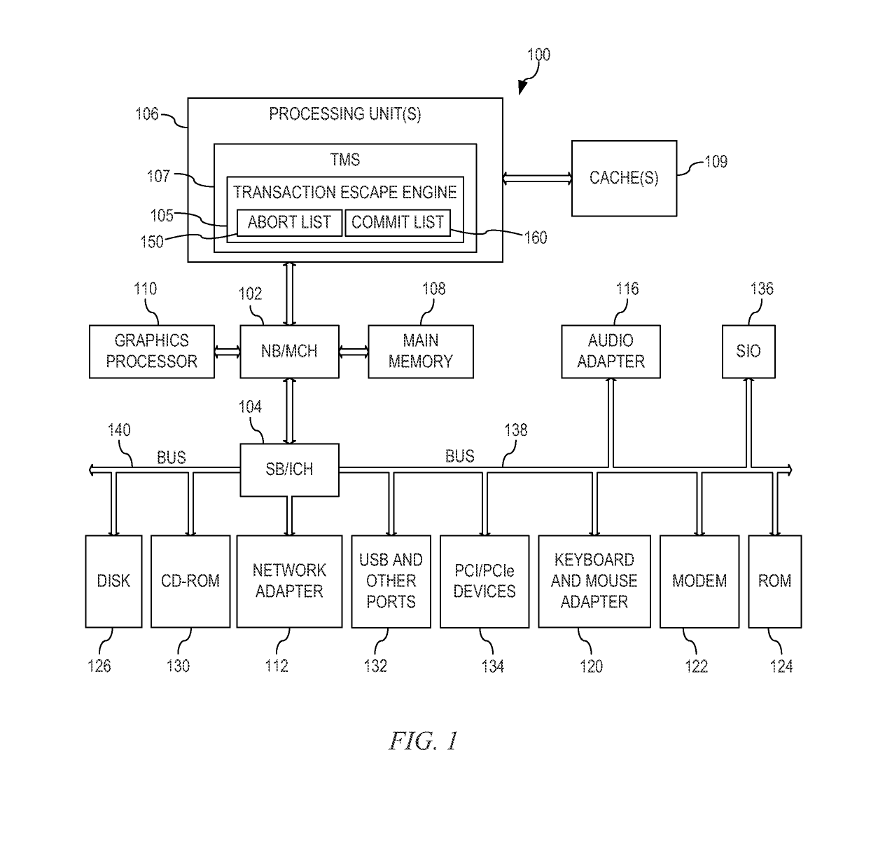

The illustrative embodiments may be utilized in many different types of data processing environments including a distributed data processing environment, a single data processing device, or the like. In order to provide a context for the description of the specific elements and functionality of the illustrative embodiments, FIG. 1 is provided hereafter as an example environment in which aspects of the illustrative embodiments may be implemented. FIG. 1 is only an example and is not intended to state or imply any limitation with regard to the various data processing system configurations, architectures, and the like, that may be used with the mechanisms of the illustrative embodiments. In short, the mechanisms of the illustrative embodiments may be implemented with any data processing system that implements a transactional memory system.

With reference now to FIG. 1, a block diagram of a data processing system is shown in which illustrative embodiments may be implemented. Data processing system 100 is an example of a computer in which computer usable code or instructions implementing the processes may be located for the illustrative embodiments.

In the depicted example, data processing system 100 employs a hub architecture including a north bridge and memory controller hub (MCH) 102 and a south bridge and input/output (I/O) controller hub (ICH) 104. Processing unit 106, main memory 108, and graphics processor 110 are coupled to north bridge and memory controller hub 102. Processing unit 106 may contain one or more processors and even may be implemented using one or more heterogeneous processor systems. Graphics processor 110 may be coupled to the MCH through an accelerated graphics port (AGF), for example.

In the depicted example, local area network (LAN) adapter 112 is coupled to south bridge and I/O controller hub 104 and audio adapter 116, keyboard and mouse adapter 120, modem 122, read only memory (ROM) 124, universal serial bus (USB) ports and other communications ports 132, and PCl/PCIe devices 134 are coupled to south bridge and I/O controller hub 104 through bus 138, and hard disk drive (HDD) 126 and CD-ROM drive 130 are coupled to south bridge and I/O controller hub 104 through bus 140. PCl/PCIe devices may include, for example, Ethernet adapters, add-in cards, and PC cards for notebook computers. PCI uses a card bus controller, while PCIe does not. Read Only Memory (ROM) 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be coupled to south bridge and I/O controller hub 104.

An operating system runs on processing unit 106 and coordinates and provides control of various components within data processing system 100 in FIG. 1. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 100. Java and all Java-based trademarks are trademarks of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processing unit 106. The processes of the illustrative embodiments may be performed by processing unit 106 using computer implemented instructions, which may be located in a memory such as, for example, main memory 108, read only memory 124, or in one or more peripheral devices.

A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted examples in FIG. 1 and above-described examples are not meant to imply architectural limitations. For example, data processing system 100 also may be a tablet computer, laptop computer, or telephone device in addition to taking the form of a PDA.

In accordance with the mechanisms of the illustrative embodiments, the data processing system of FIG. 1 implements a transactional memory system 107. This transactional memory system 107 may be implemented with regard to one or more caches 109 associated with the processing unit(s) 106, the main memory 108, a combination of caches 109 and main memory 108, or the like. As noted above, the transactional memory system 107 may be implemented as a hardware transactional memory system, software transactional memory system, or a hybrid hardware/software transactional memory system. In accordance with the illustrative embodiments, a hybrid hardware/software transactional memory system 107 is utilized in which transaction escape engine 105 is provided in the processing unit(s) 106 and software mechanisms are executed by the processing units 106 to support transaction escape actions with regard to the transactional memory system 107.

For example, the transactional memory system 107 may make use of hardware primitives that are commands recognizable by the hardware of the transactional memory system 107 to cause various transaction operations to be performed within the hardware. For example, these hardware primitives may be written directly in assembly or machine language or generated by a compiler translating high-level programmer code. These transaction hardware primitives may comprise a transaction_begin, transaction_end, transaction_abort, transaction_suspend, and transaction_resume hardware primitive command. The transaction_begin hardware primitive command marks the beginning of a transaction in code and enables the hardware logic of the transactional memory system 107 to begin conflict detection, automatic commit of a transaction if it can complete successfully, and automatic abort of a transaction if it cannot complete successfully. The transaction_end hardware primitive command causes the hardware logic of the transactional memory system 107 to commit the transaction and end the transactional execution state. The transaction_bort hardware primitive command causes the hardware logic of the transactional memory system 107 to abort the transaction by rolling back the changes made by the transaction, end the transactional execution state, and transfer control to an abort handler of the operating system, executing on a corresponding processing unit 106, to perform further processing of the code in view of the occurrence of the transaction abort, e.g., restarting the transaction, or the like.

The transaction_suspend hardware primitive command causes the hardware logic of the transactional memory system 107 to suspend the transactional execution of a transaction. The suspension of a transaction causes the exclusion of the execution of subsequent instructions (until a transaction_resume operation is performed) from: conflict detection by the transactional memory system; (b) consumption of transactional memory systems resources; and in some cases, (c) respecting transactional memory system rules prohibiting certain actions (some implementations may not suspend certain rules during execution in a suspended mode). To suspend a transaction also means that the subsequent instructions (until a transaction_resume operation, take effect immediately and are not undone if the transaction is aborted. The transaction_resume hardware primitive command causes the hardware logic of the transactional memory system 107 to resume transactional execution of a previously suspended transaction.

The transaction escape engine 105 may comprise logic, in software and/or hardware, for maintaining, for each thread being executed by corresponding processing units 106, such as in their corresponding thread contexts or the like, an abort actions list 150 and a commit actions list 160. The abort actions list 150 and commit actions list 160, for each thread of execution or possible thread of execution of a corresponding processing unit 106, may be stored in hardware storage devices, for example, such as registers, a memory, or the like.

The transaction escape engine 105 may further comprise logic for utilizing these lists 150, 160 in the event of a transaction abort or transaction commit. For example, the transaction escape engine 105 may provide logic for executing the operations or actions in the commit actions list 160 in response to the transaction committing successfully. The transaction escape engine 105 may further provide logic for executing operations or actions in the abort actions list 150 in the event of the transaction being aborted. This may include invoking an abort handler to handle the operations or actions in the abort actions list 150, for example. The transaction escape engine 105, if implemented in software or a combination of software and hardware, may be fully or partially integrated with the operating system, for example, or may be provided as a separate software entity that operates in conjunction with the operating system.

It should be noted that while FIG. 1 shows only a single transaction escape engine 105, there may be multiple transaction escape engines 105 provided in an architecture in which there are multiple processing units 106, e.g., one for each processing unit 106. Alternatively, a single transaction escape engine 105 may be provided for a plurality of processing units 106 and may operate with regard to hardware or software threads on one or more of the plurality of processing units 106 to permit escape actions within transactions of these various threads, as described hereafter. That is, in embodiments where the commit action list 150 and abort action list 160 are maintained in software structures, the transaction escape engine 105 may operate with regard to software threads, for example.

Moreover, while only one abort action list 150 and commit action list 160 are shown in FIG. 1, there may be an abort action list 150 and a commit action list 160 for each thread of execution currently being executed by a corresponding processing unit 106, or for each thread of execution that is capable of being executed by the processing unit 106. Thus, for example, in one illustrative embodiment, if the processing unit 106 is a simultaneously multi-threaded (SMT) processor that is currently executing two threads simultaneously, i.e. it is an SMT-2 processor, then the transaction escape engine 105 may create and manage two abort action lists 150 and two commit action lists 160, one for each currently executing thread. Alternatively, if the processing unit 106 is an SMT-2 processor, but only one thread is currently executing, the transaction escape engine 105 may still create and manage two of each list 150, 160 since the processor is capable of executing up to 2 threads simultaneously.

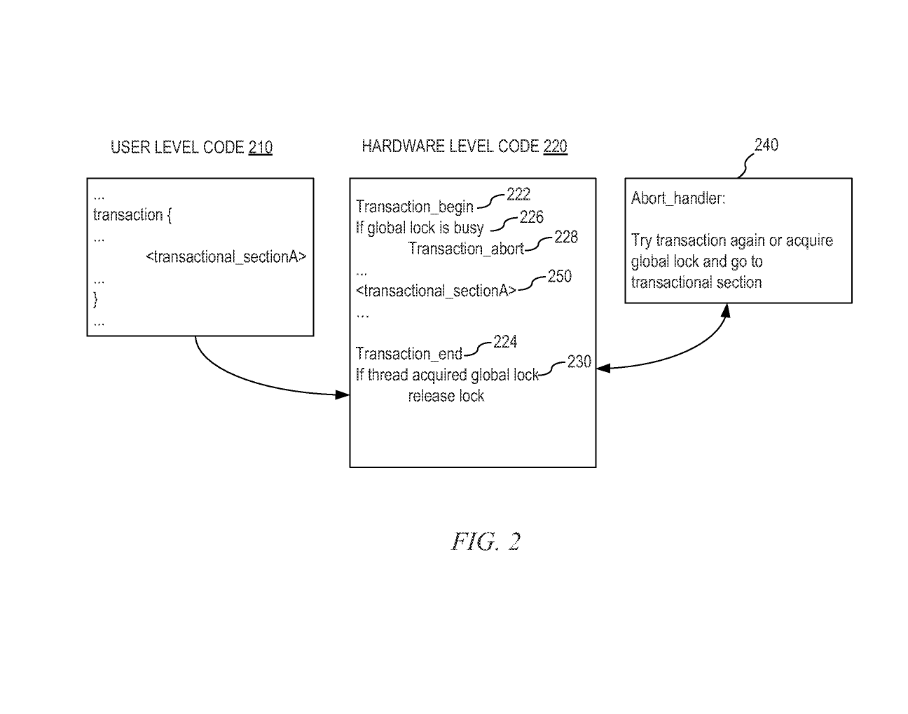

To better understand the improvements made by transactional memory system of the illustrative embodiments, reference is now made to FIG. 2 which is an example diagram illustrating an example portion of pseudocode that utilizes hardware transactional memory system. It should be appreciated that the example shown in FIG. 2, and examples in figures described hereafter, uses pseudocode to ease explanation and understanding. The actual code that would be generated would look different, but would perform the operations outlined in the depicted pseudocode.

As shown in FIG. 2, a programmer may generate a portion of code 210 that is to be performed as a single transaction. This user level code is then transformed by a compiler into hardware level code 220 that utilizes hardware transaction primitive commands for instructing the hardware transactional memory system logic how to operate with regard to the execution of the transaction specified in the hardware level code 220. As can be seen in FIG. 2, the code for performing the transaction 210 has been converted to a hardware level transaction code that includes the transaction_begin hardware transaction primitive command 222 to specify the beginning of the transaction and a transaction_end hardware transaction primitive command 224 to specify the end of the transaction. Additional code 226 is provided for checking whether a global lock on one or more memory locations that are to be accessed by the transaction is busy and if so, a transaction_abort hardware transaction primitive command 228 is provided for aborting the transaction. Code 330 for releasing a global lock in response to successful completion of the transaction may also provided.

An abort handler 240 may be provided for performing operations in the event that a transaction aborts. The abort handler 240 may, for example, retry the transaction or try to acquire the global lock and then perform the transaction.

In the depicted example of FIG. 2, the transactional section 250, or body of the transaction, comprises operations that are to be performed as part of the transaction, i.e. as an atomic unit. During execution of the transactional section 250, or body, of the transaction, the transaction memory system checks the operations in this transaction for conflicts with other transactions accessing a same portion of memory. If a conflict is detected, then the transaction is aborted. These checks consume resources of the transactional memory system.

In the example depicted in FIG. 2, there are no portions of the transaction section that might cause issues with the ability to perform these conflict checks, however in some instances the transaction body may include operations that may cause issues with the ability to perform these conflict checks, or otherwise include operations that have other consistency mechanisms for ensuring the correct execution of these operations with regard to the memory, as previously mentioned above. These sections of code are referred to herein as escape actions as noted above. These escape actions comprise non-transactional code portions that are to be executed in a non-transactional manner without the transaction guarantees of atomicity. For example, a memory allocation operation (malloc), statistic calculation operation, logging operation, or the like, may be provided as a non-transactional operation, i.e. an operation that can be executed without the need for a guarantee of transaction atomicity, which may be contained in the body of the transaction.

It may be difficult in some instances to move such non-transactional sections of code outside of a transaction. For example, consider the following example code:

r1=Size;

r2=(data type*) malloc(r2);

r2->Field=value; In this example, it is difficult to move the call to memory allocation (malloc) outside the body of the transaction. Malloc depends on the value of Size, read in the transaction, and the write to the field named “Field” depends on the result of malloc. However, the programmer wants to exclude malloc from the transaction because, for example, it already has its own synchronization mechanism and including it may increase changes of a conflict with the transaction. As a result, the programmer may specify the malloc operation as an escape action so as to allow the malloc operation to be performed in a non-transactional manner but without having to move the call to malloc outside the transaction.

A programmer may specify the escape action in the user level code as well as the actions to be performed when a transaction having the escape action as part of the transaction code either commits or aborts. This user level code may be converted to a hardware level code by a compiler using the hardware transaction primitives previously mentioned above. That is, the compiler may convert the user level code to a hardware level code that uses the transaction_begin, transaction_abort, transaction_suspend, transaction_resume, and transaction_end hardware transaction primitive commands to control the execution of the transaction such that non-transactional portions, i.e. escape actions, within the transaction code may be performed in a non-transactional manner without modifying the body of the transaction and while performing appropriate operations with regard to the escape action upon commit or abort of the transaction.

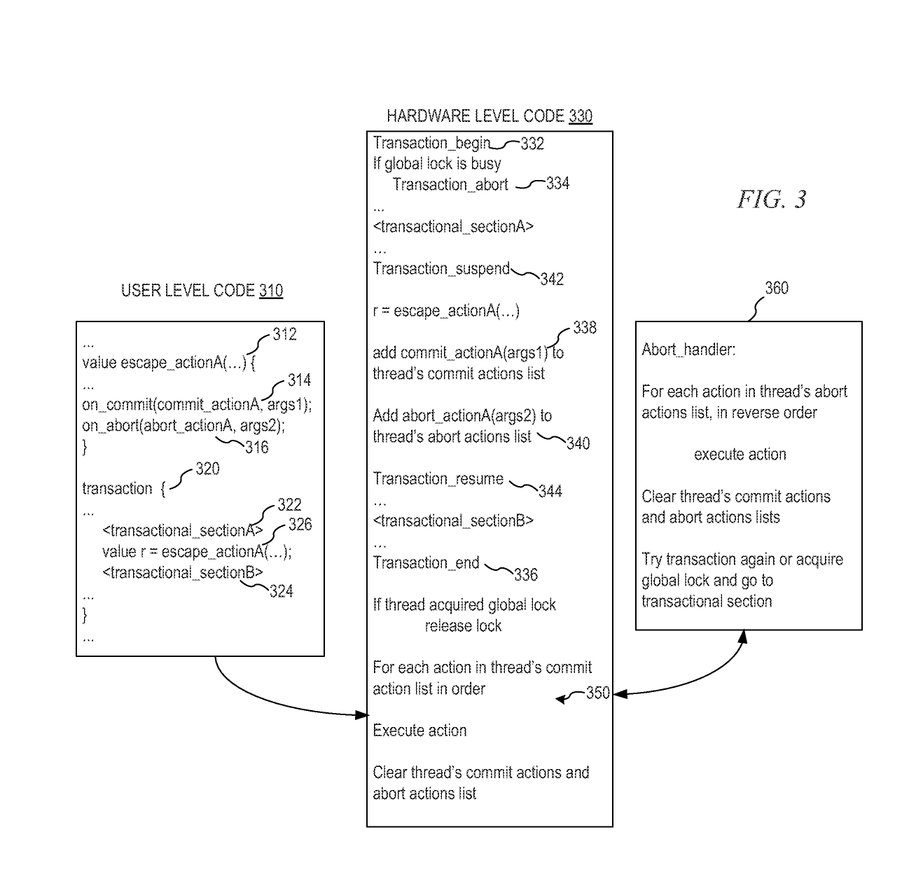

FIG. 3 is an example diagram of code that may be used for executing a transaction having an escape action in accordance with one illustrative embodiment. As shown in FIG. 3, a programmer may generate a portion of user level code 310 that includes the definition of an escape action 312, which in this case is escape_actionA( . . . ). Within the definition of the escape action 312, there is a definition of the actions to be performed, and their corresponding arguments, when a transaction having the escape action in the transaction is committed or aborted. In the depicted example, escape_actionA( . . . ) has an on_commit(commit_actionA, args1) statement 314 and on_abort(abort_actionA, args2) statement 316 defining the actions and corresponding arguments to be performed on commit or on abort of the transaction, respectively.

The user level code 310 further includes a definition of a transaction 320 which includes transactional code portions 322 and 324 and an escape action 326. The escape action 326 in the body of the transaction 320 references the escape action definition 312. The transactional code portions 322 and 324 are part of the transaction and are intended to be executed with the transactional guarantees of atomicity in place. The non-transactional escape action 326 may be executed as part of the transaction, but may also cause issues with the transactional memory system since it may be a portion of code that often causes conflicts or other issues but for which there are other mechanisms in place in the computer system to ensure correctness of the operation of the non-transactional escape action 326 portion of code.

A compiler, in accordance with the mechanisms of the illustrative embodiments, compiles the user level code 310 to create hardware level code 330. In this process, the compiler inserts appropriate hardware transaction primitive commands to begin the transaction 332, abort the transaction 334, and end the transaction 336. In addition, with regard to the escape action 326, the compiler inserts instructions 338, 340 for adding the commit actions specified in the on commit statement 314 and abort actions specified in the on_abort statement 316 to corresponding commit action and abort action list data structures associated with the currently executing thread.

The illustrative embodiments utilize the hardware transaction primitive commands to insert an appropriate transaction suspend hardware transaction primitive command 342 prior to the escape action 326 in the hardware level code 330 and an appropriate transaction_resume hardware transaction primitive command 344 following the escape action 326 and the inserted instructions 338, 340 for adding actions to the commit action and abort action list data structures. Once the transaction is suspended using the transaction suspend hardware transaction primitive command 342, the execution of the escape action 326 may be performed in a non-transactional manner without utilizing the transactional memory system atomicity mechanisms for the operations performed by the escape action.

In other words, the effects of the main body of the escape action 326 are immediate and not delayed until a commit time. Moreover, these effects are not subject to roll back in the case of the transaction aborting. The commit actions list provides a mechanism to postpone certain actions after the commit of the transaction (if this happens) without requiring the programmer to complicate the code to remember to do these commit actions explicitly. For example, a programmer can include escape_free( ) in a transaction and the escape action mechanism adds the actual free operation to the commit actions list and causes it to be executed only if the transaction commits. As another example, with regard to the malloc operation previously discussed, the malloc needs to be executed immediately so that its result can be used and, in addition, an abort action to free the allocated block needs to be provided in case the transaction aborts and thus, the allocation can be freed for reuse.

Code 350 is provided following the transaction for performing cleanup operations following execution of the transaction. The code 350, for example, may release global lock acquired when performing the transaction. In addition, the code 350 comprises code for executing the actions stored in the commit actions list data structure in an in-order manner, i.e. in the order in which the actions are added to the commit actions list data structure. Once each action in the commit actions list data structure is executed, the thread's commit action list and abort action list are cleared.

In addition, an abort handler 360 is provided that includes code for executing the actions in the thread's abort action list in the event that the transaction is aborted. The actions in the thread's abort action list are executed in a reverse order, e.g., in an order where a last added action in the abort actions list data structure is executed first followed by the immediately preceding action in the abort actions list data structure, and so on. Once the actions in the abort actions list are executed in a reverse order, the thread's commit action list and abort action list are cleared and the transaction may be retried or the global lock may be botained and the operation may go to the first transactional section of the transaction.

Thus, during execution, when the transaction begins, a determination is made as to whether a global lock required for performing the transaction on one or more memory locations is busy or not. If the global lock is busy, then the transaction is aborted, any changes are rolled-back, and the operation branches to the abort handler 360. If the global lock is not busy, the transaction body may be executed, i.e. the transactional_sectionA. While executing the body of the transaction, the transaction may be suspended by the transaction_suspend hardware transaction primitive command 342 so that an escape action 326 may be executed. The escape action 326 may be executed in a non-transactional manner with corresponding commit actions and abort actions being added to the thread's commit actions list and abort actions list. Once the escape action has been executed, the transaction may be resumed using a transaction_resume hardware transaction primitive command 344. A subsequent portion of the transaction body may then be executed in a transactional manner, i.e. transactional_sectionB.

If the transaction ends sucessfully, then the portion of code 350 is executed so that the actions in the thread's commit actions list are executed, and the commit actions list and abort actions list are cleared. During the execution of the body of the transaction, if a conflict is encountered, the transaction may be aborted in which case the execution branches to the abort handler 360. The abort handler 360 performs an abort action by executing the actions in the abort actions list associated with the thread in a reversed order, the commit actions list and abort actions list are cleared, and the transaction is either tried again, or the global lock is acquired and the execution gos to the first transaction section, i.e. transacitonal_sectionA.

It should be noted that while only one escape action is shown in this example, the illustrative embodiments are not limited to such. To the contrary, any number of escape actions and transaction body portions may be used without departing from the spirit and scope of the illustrative embodiments.

With the mechanisms of the illustrative embodiments, it should be noted that the transactional sections in the body of the transaction do not need to be modified in order to execute the escape action. The use of the hardware transaction primitive commands in the body of the transaction permits the transaction to be suspended so that the escape action can be executed without having to modify the transactional sections in the body of the transaction. If a software transaction mechanism were used instead, the body of the transaction would need to be modified to perform additional read and write operaitons or other types of instructions to maintain the data of the transaction in memory while the escape action is executed. Thus, since the transaction body does not need to be modified in order to implement the efficient escape action operations in accordance with the illustrative embodiments, the mechanisms of the illustrative embodiments may be employed with legacy transaction code without modification of the legacy transaction code.

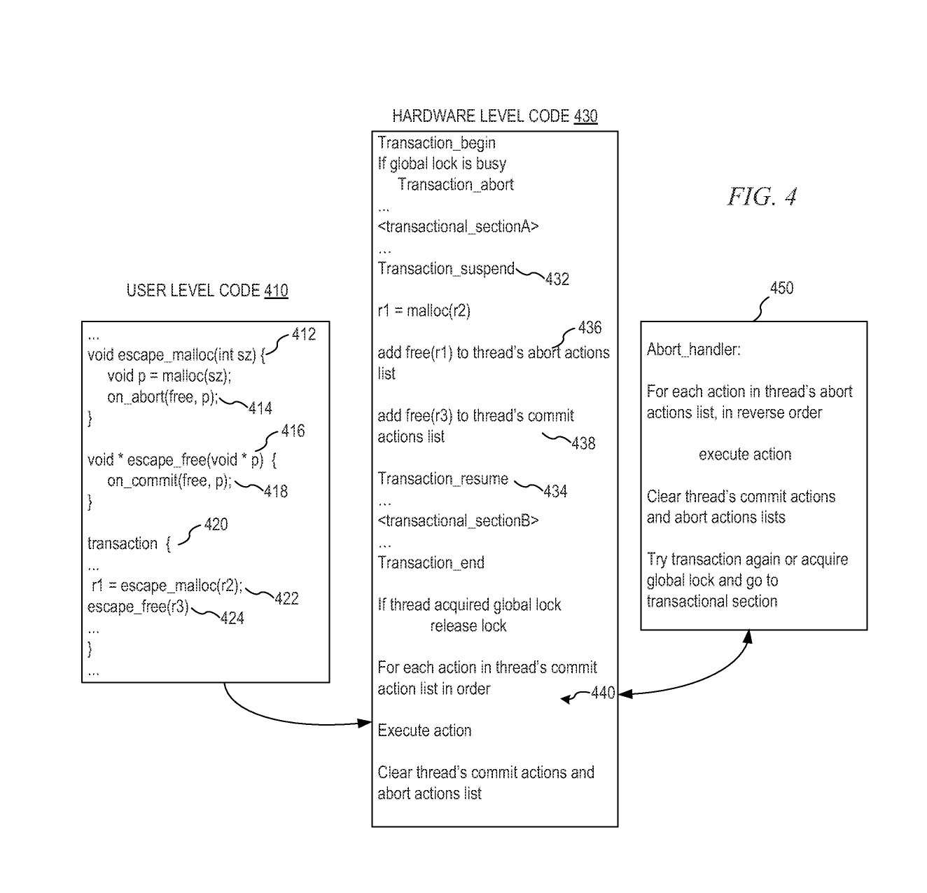

FIG. 4 is an example diagram of code implementing a memory allocation escape action in a transaction in accordance with one illustrative embodiment. As shown in FIG. 4, the original user level code 410 includes a memory allocation (malloc) instruction for which an escape action, i.e. escape_malloc(int sz) 412 is defined. In the definition of the escape_malloc(int sz) escape action 412, a statement 414 specifying the actions to add to the thread's abort actions list is provided, i.e. on_abort(free, p). In addition, a definition of a second escape action 416, i.e. escape_free(void*p) is provided. In this definition of the second escape action 416, a statement 418 is provided for specifying actions to be added to the thread's commit action list, i.e. on_commit(free, p). Thereafter, the transaction is specified 420 in which the body of the transaction includes references to the escape actions escape_malloc(r2) 422 and escape_free(r3) 424.

The compiler takes the user level code 410 and performs optimizations and transformations to generate hardware level code 430 which includes hardware transaction primitive commands/instructions that direct logic in the hardware transaction memory system to perform various operations for implementing a transaction within the hardware logic. As shown in FIG. 4, in the depicted example, with regard to the escape action, a transaction suspend command 432 and transaction resume command 434 are inserted into the code around the escape action which is executed in a non-transactional manner. As shown, the escape action, i.e. r1=malloc(r2), has associated with it the instructions 436 and 438 for adding the actions specified in the user level code 410 to the thread's abort actions list and commit actions list. Moreover, the hardware level code 430 further includes instructions 440 for performing actions in the thread's commit action list in an in-order manner, and clearing the thread's commit actions list and abort actions list in the event of a transaction successful completion. An abort handler 450 is provided that includes instructions for executing actions in the abort actions list of the thread, clearing the commit actions and abort actions list, and then either retrying the transaction of acquiring the global lock and going to the beginning of the transactional section in the body of the transaction, in the event of a transaction abort occurring.

Thus, with the code in FIG. 4, the free(r1) action is added to the thread's abort actions list and the free(r3) action is added to the thread's commit actions list. If the transaction aborts, then the action free(r1) will be executed from the thread's abort actions list by the abort handler 450. If the thread commits successfully, then the hardware level code 430 will cause the free(r3) action to be executed as part of executing the actions in the thread's commit actions list. The actions in the commit actions list are performed in order and the actions in the abort actions list are performed in a reverse manner.

It should be noted that while the above description assumes a single transaction, the illustrative embodiments are not limited to such. To the contrary, the mechanisms of the illustrative embodiments may be implemented with nested transactions, i.e. transactions within transactions, as well without departing from the spirit and scope of the illustrative embodiments. Furthermore, while the depicted examples refer to a global lock being acquired by the transaction, the illustrative embodiments are not limited to such. Rather, any transaction mechanism may be used with the mechanisms of the illustrative embodiments and thus, various mechanisms for ensuring consistency of the memory or atomicity of the transaction may be used without departing from the spirit and scope of the illustrative embodiments.

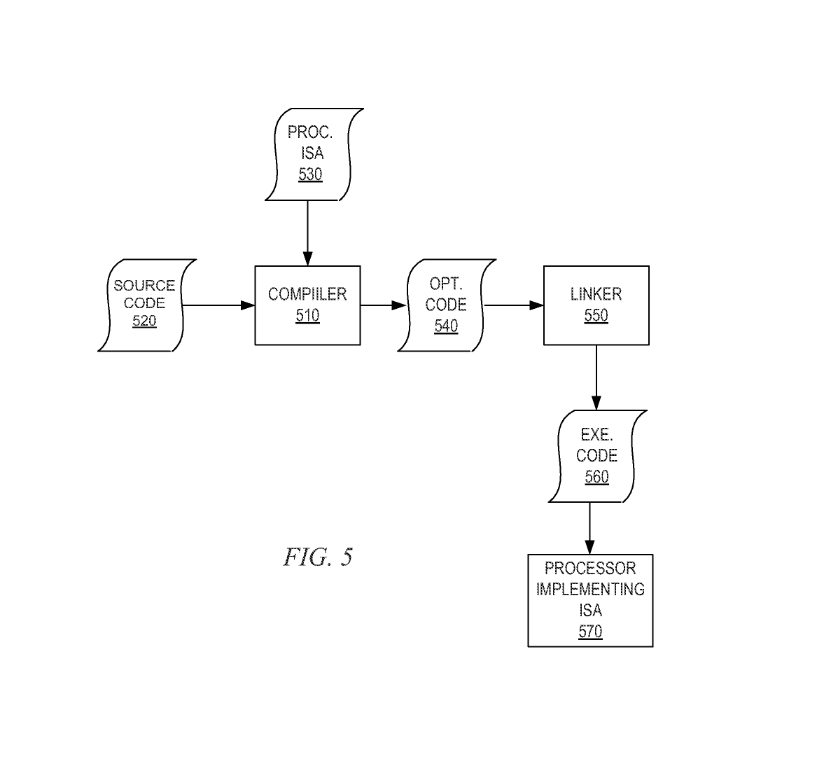

As discussed above, the illustrative embodiments make use of a compiler to optimize and transform user level code in which transactions, escape actions, and commit/abort actions are identified, into hardware level code that utilizes hardware transaction primitive commands and additional commands for generating and using a commit actions list and an abort actions list. FIG. 5 is an example diagram illustrating a compilation process that may be implemented using a compiler that is configured to perform the operations for transforming and optimizing user level code into code utilizing the mechanisms of the illustrative embodiments.

As shown in FIG. 5, the compiler 510 receives original source code 520 which is analyzed in accordance with source code patterns associated with the processor architecture 530 for which the compiler 510 is configured. The compiler 510 identifies portions of the source code 520 that meet the source code patterns corresponding to the processor architecture 530.

The compiler then transforms the source code to utilize the instruction set architecture of the processor architecture 530 which includes the hardware transaction primitive instructions/commands, and the instructions for generating, populating, and using the commit actions list and abort actions list described above. The result is optimized code 540 that implements the processor architecture's instruction set architecture and the instructions/commands of the illustrative embodiments described above. This optimized code 540 is then provided to linker 550 that performs linker operations, as are generally known in the art, to thereby generate executable code 560. The executable code 560 may then be executed by the processor architecture.

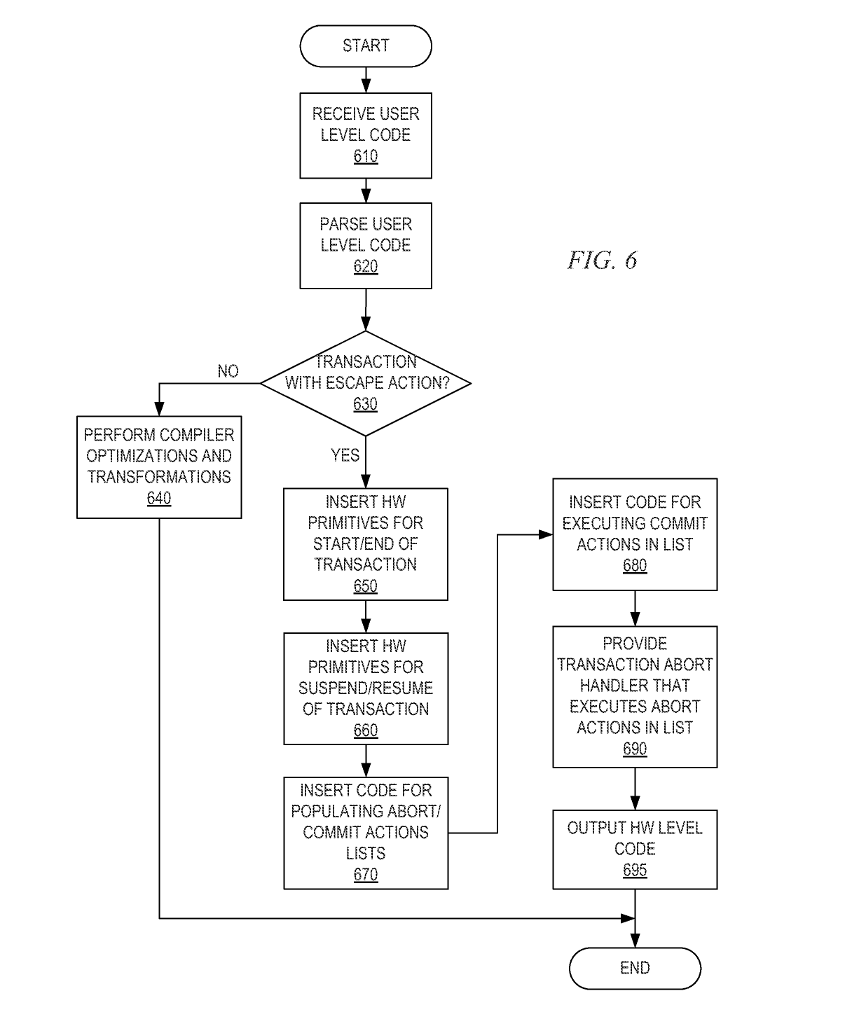

FIG. 6 is a flowchart outlining an example operation for generating hardware level code from user level code in accordance with one illustrative embodiment. The operation outlined in FIG. 6 may be implemented, for example, by a compiler, such as compiler 510 in FIG. 5 for example, or the like.

As shown in FIG. 6, the operation starts by receiving user level code that defines at least one transaction and at least one escape action along with the actions to be added to a thread's commit actions list and abort actions list for the at least one escape action (step 610). The transaction preferably includes a transactional section or body that makes reference to one or more of the at least one escape action. The compiler parses the user level code (step 620) and determines if there is a transaction referencing an escape action present in the user level code (step 630). If not, the operation performs known compiler optimizations and transformations and generates hardware level code (step 640) with the operation terminating thereafter.

If the user level code includes a transaction that references an escape action, then hardware transaction primitive commands/instructions for starting and ending the transaction are inserted into the hardware level code generated by the compiler (step 650). Transaction suspend hardware transaction primitive commands/instructions are inserted into the code prior to the escape action(s) and transaction resume hardware transaction primitive commands/instructions are inserted into the code after the escape action(s) (step 660). Code for populating a thread's commit actions list and abort actions list is inserted in association with the escape action based on the definition of actions to add to these lists as specified in the user level code (step 670). Code for executing actions in the commit actions list in order and clearing the commit actions list and abort actions list is inserted after the transaction in the hardware level code (step 680). A transaction abort handler is generated that includes code for executing actions in the abort actions list in a reverse order and for clearing the commit actions list and abort actions list (step 690). The hardware level code is then output for use in generating the executable code (step 695) and the operation terminates.

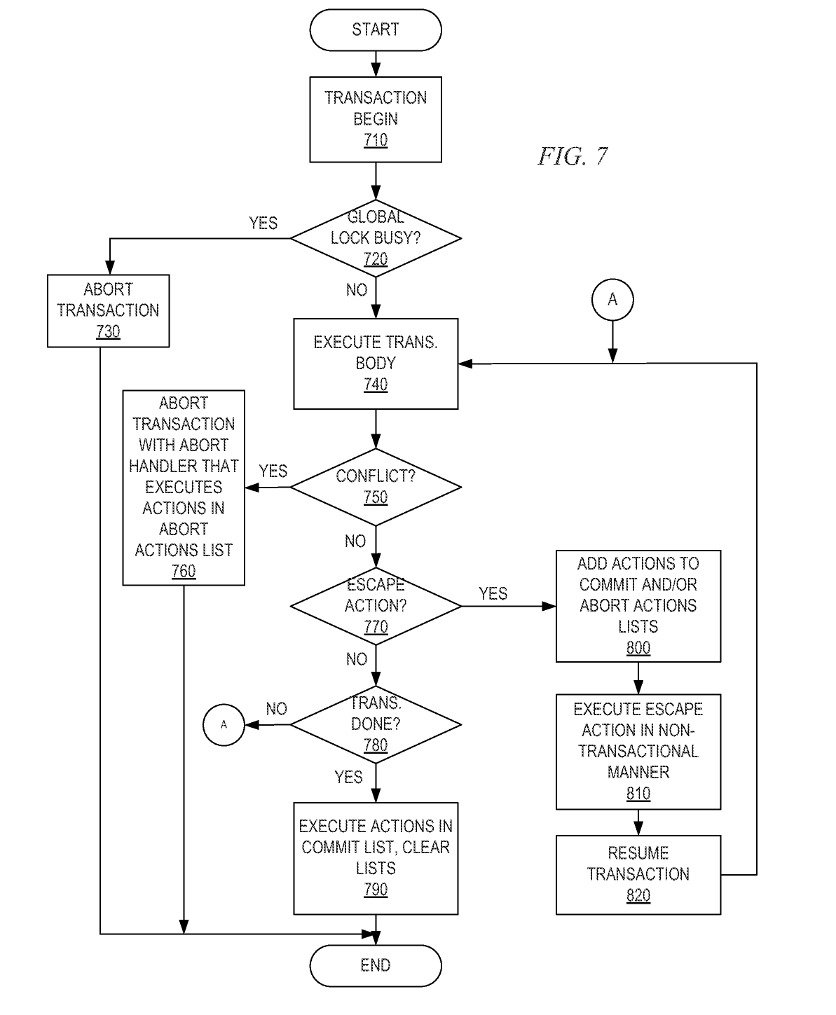

FIG. 7 is a flowchart outlining an example operation of the execution of a transaction that includes an escape action in accordance with one illustrative embodiment. The operation outlined in FIG. 7 may be implemented, for example, by a processor of a data processing system utilizing hardware logic of a hardware transactional memory system in accordance with one illustrative embodiment.

As shown in FIG. 7, the operation starts by detecting a transactional portion of code to be executed, e.g., by encountering a transaction begin hardware transaction primitive command/instruction (step 710). A determination is made as to whether the global lock required for performance of the transaction is busy or not (step 720). If so, then the transaction is aborted and an abort handler is called (step 730). If not, then the transactional section or body begins to execute (step 740).

A determination is made as to whether a conflict arises during execution of the transaction (step 750). If so, then the transaction is aborted and an abort handler is called (step 760). As discussed above, the abort handler has code for executing actions in an abort actions list associated with the thread and for clearing the abort actions list and commit actions list with a subsequent retry of the transaction or obtaining of the global clock and execution of the transactional section or body of the transaction.

If no conflict is detected in step 750, then a determination is made as to whether an escape action is encountered (step 770). If not, then a determination is made as to whether the transaction has completed (step 780). If the transaction has not completed, the operation returns to step 740 where the transactional section or body of the transaction continues to be processed. If the transaction has completed, then the actions in the thread's commit actions list are executed, and the commit actions list and abort actions List are cleared (step 790), and the execution of the transaction is terminated.

If there is an escape action (step 770), then the actions associated with the escape action that are to be added to the commit actions list and abort actions list for the present thread are added to these list data structures (step 800) and the escape action is executed in a non-transactional manner (step 810). Once the escape action is complete, the transaction is resumed (step 820) and the operation returns to step 740 where the transactional section or body of the transaction continues to be processed.

Thus, the illustrative embodiments provide mechanisms for efficiently handling escape actions in transactions such that portions of code of a transaction that may be problematic for transactional atomicity can be executed in a non-transactional manner without having to significantly modify the code of the transaction. The illustrative embodiments utilize a commit actions list and abort actions list for the threads as a way of ensuring that appropriate actions associated with the escape action are performed in response to either the successful completion of a transaction or the abort of the transaction. The illustrative embodiments utilize hardware transaction primitive commands/instructions to facilitate the suspending of the transaction so that the escape action can be executed and then the resuming of the transaction after the escape action has been executed.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for performing escape actions within transactions, comprising:
executing, by a processor of the data processing system, a transaction comprising a transactional section and an escape action, wherein the transactional section is comprised of one or more instructions that are to be executed in an atomic manner as part of the transaction, and wherein the escape action is comprised of one or more instructions to be executed in a non-transactional manner;
populating, by the processor, at least one actions list data structure, associated with a thread of the data processing system that is executing the transaction, with one or more actions associated with the escape action; and
executing, by the processor, one or more actions in the at least one actions first data structure based upon whether the transaction commits successfully or is aborted.

2. The method of claim 1, wherein the at least one actions list data structure comprises a commit actions list data structure associated with the thread and an abort actions list data structure associated with the thread, wherein actions listed in the commit actions list data structure are executed in response to the transaction committing successfully, and wherein actions listed in the abort actions list data structure are executed in response to the transaction aborting.

3. The method of claim 2, wherein the actions listed in the commit actions list data structure are executed in order, and wherein actions listed in the abort actions list data structure are executed in a reverse order.

4. The method of claim 1, wherein the escape action comprises a portion of code that is determined to likely cause an abort of the transaction if the portion of code is executed in a transactional manner.

5. The method of claim 1, wherein executing the transaction comprising the transactional section and the escape action comprises executing one or more hardware primitive commands to suspend execution of the transactional section prior to execution of the escape action, and one or more hardware primitive commands to resume the execution of the transactional section after completion of the execution of the escape action.

6. The method of claim 1, wherein the escape action comprises instructions for populating the at least one actions list data structure with actions to be executed in response to one or more of a successful commit of the transaction or an abort of the transaction.

7. The method of claim 1, wherein:
the transaction is a portion of hardware level code generated by a compiler from user level code,
the escape action is a portion of the hardware level code that is to be executed in a non-transactional manner, and
the compiler inserts a hardware primitive command into the hardware level code for suspending the transaction prior to the escape action in the hardware level code, and inserts a hardware primitive command into the hardware level code for resuming the transaction after the escape action in the hardware level code.

8. The method of claim 7, wherein the compiler inserts instructions into the escape action in the hardware level code to populate the at least one actions list data structure with actions specified in the user level code to be performed in response to at least one of a successful commit of the transaction or an abort of the transaction.

9. The method of claim 8, wherein the compiler inserts instructions into the hardware level code to execute actions in the at least one actions list data structure, in order, in response to a successful commit of the transaction.

10. The method of claim 1, further comprising:
providing an abort handler to be executed by the processor in response to an abort of the transaction, wherein the abort handler comprises instructions for executing actions in the at least one actions list data structure in a reverse order.

11. A computer program product for performing escape actions within transactions, the computer program product comprising:
a computer readable storage medium;
first program instructions to execute a transaction comprising a transactional section and an escape action, wherein the transactional section is comprised of one or more instructions that are to be executed in an atomic manner as part of the transaction, and wherein the escape action is comprised of one or more instructions to be executed in a non-transactional manner;
second program instructions to populate at least one actions list data structure, associated with a thread of the data processing system that is executing the transaction, with one or more actions associated with the escape action;
third program instructions to execute one or more actions in the at least one actions list data structure based upon whether the transaction commits successfully or is aborted; and
wherein the first, second, and third program instructions are stored on the computer readable storage medium.

12. The computer program product of claim 11, wherein the at least one actions list data structure comprises a commit actions list data structure associated with the thread and an abort actions list data structure associated with the thread, wherein actions listed in the commit actions list data structure are executed in response to the transaction committing successfully, and wherein actions listed in the abort actions list data structure are executed in response to the transaction aborting.

13. The computer program product of claim 12, wherein the actions listed in the commit actions list data structure are executed in order, and wherein actions listed in the abort actions list data structure are executed in a reverse order.

14. The computer program product of claim 11, wherein the escape action comprises a portion of code that is determined to likely cause an abort of the transaction if the portion of code is executed in a transactional manner.

15. The computer program product of claim 11, wherein the first program instructions to execute the transaction comprises program instructions to execute one or more hardware primitive commands to suspend execution of the transactional section prior to execution of the escape action, and one or more hardware primitive commands to resume the execution of the transactional section after completion of the execution of the escape action.

16. The computer program product of claim 11, wherein the escape action comprises instructions for populating the at least one actions list data structure with actions to be executed in response to one or more of a successful commit of the transaction or an abort of the transaction.

17. The computer program product of claim 11, wherein:
the transaction is a portion of hardware level code generated by a compiler from user level code,
the escape action is a portion of the hardware level code that is to be executed in a non-transactional manner, and
the compiler inserts a hardware primitive command into the hardware level code for suspending the transaction prior to the escape action in the hardware level code, and inserts a hardware primitive command into the hardware level code for resuming the transaction after the escape action in the hardware level code.

18. The computer program product of claim 17, wherein the compiler inserts instructions into the escape action in the hardware level code to populate the at least one actions list data structure with actions specified in the user level code to be performed in response to at least one of a successful commit of the transaction or an abort of the transaction.

19. The computer program product of claim 18, wherein the compiler inserts instructions into the hardware level code to execute actions in the at least one actions list data structure, in order, in response to a successful commit of the transaction.

20. The computer program product of claim 11, further comprising fourth program instructions to provide an abort handler to be executed by a processor in response to an abort of the transaction, wherein the abort handler comprises instructions for executing actions in the at least one actions list data structure in a reverse order.

21. An apparatus, comprising:
a processor; and
a memory coupled to the processor, wherein the memory comprises instructions which, when executed by the processor, cause the processor to:
execute a transaction comprising a transactional section and an escape action, wherein the transactional section is comprised of one or more instructions that are to be executed in an atomic manner as part of the transaction, and wherein the escape action is comprised of one or more instructions to be executed in a non-transactional manner;
populate at least one actions list data structure, associated with a thread of the data processing system that is executing the transaction, with one or more actions associated with the escape action; and
execute one or more actions in the at least one actions list data structure based upon whether the transaction commits successfully or is aborted.

22. The apparatus of claim 21, wherein the at least one actions list data structure comprises a commit actions list data structure associated with the thread and an abort actions list data structure associated with the thread, wherein actions listed in the commit actions list data structure are executed in response to the transaction committing successfully, and wherein actions listed in the abort actions list data structure are executed in response to the transaction aborting.

23. The apparatus of claim 22, wherein the actions listed in the commit actions list data structure are executed in order, and wherein actions listed in the abort actions list data structure are executed in a reverse order.

24. The apparatus of claim 21, wherein the escape action comprises a portion of code that is determined to likely cause an abort of the transaction if the portion of code is executed in a transactional manner.

25. The apparatus of claim 21, wherein executing the transaction comprising the transactional section and the escape action comprises executing one or more hardware primitive commands to suspend execution of the transactional section prior to execution of the escape action, and one or more hardware primitive commands to resume the execution of the transactional section after completion of the execution of the escape action.
